(19) United States
(12) Patent Application Publication
(10) Pub. No.: US 2011/0050850 A1
(43) Pub. Date: Mar. 3, 2011

(54) VIDEO COMBINING DEVICE, VIDEO DISPLAY APPARATUS, AND VIDEO COMBINING METHOD

(75) Inventor: Masahiro Yamada, Tokyo (JP)

(73) Assignee: KABUSHIKI KAISHA TOSHIBA, Tokyo (JP)

(21) Appl. No.: 12/819,989

(22) Filed: Jun. 21, 2010

(30) Foreign Application Priority Data
Aug. 31, 2009 (JP) 2009-200812

(51) Int. Cl. H04N 13/04; H04N 13/00

(52) U.S. Cl. 348/43; 348/51; 348/E13.001; 348/E13.075

(57) ABSTRACT

According to embodiments described herein, there is provided a video combining device including: a frame extraction module configured to extract left-eye frames and right-eye frames; a graphic object generation module configured to generate a left-eye object and a right-eye object; a combined image generation module configured to generate combined left-eye frames/combined right-eye frames by synchronizedly combining those with the left-eye object/right-eye object, respectively; a frame group generation module configured to generate a left-eye frame group and a right-eye frame group by performing a frame interpolation based on the combined left-eye frames and the combined right-eye frames; and an image output module configured to alternately output the left-eye frame group and the right-eye frame group so as to sequentially rewrite the screen.

### CROSS-REFERENCE TO RELATED APPLICATIONS

This application is based upon and claims the benefit of priority from Japanese Patent Application No. 2009-200812, filed on Aug. 31, 2009, the entire contents of which are incorporated herein by reference.

### BACKGROUND

1. Field

Embodiments described herein relate generally to a video combining device, a video display apparatus, and a video combining method for generating and displaying a graphic object such as an on-screen display image.

2. Description of the Related Art

In recent years, TV receivers and video, monitors having a function of displaying a stereographic (3D) video content have spread widely. And, many 3D video contents have come to be provided by many broadcasting companies and content servers on the Internet. In many cases, a 3D video signal of a 3D video content is different from a two-dimensional (2D) video signal of a common 2D video content. For practice use of such a 3D video signal, various techniques have been disclosed or implemented.

For example, JP-2007-110683-A (FIG. 1 and Paragraph 0025) discloses a technique for controlling the opening/closing timing of electronic shutters in a 3D video apparatus including a storage/overwriting-type display (such as an LCD which is commonly available on the market) and glasses having electronic shutters.

On the other hand, TV receivers and video monitors which display a video signal of a 2D video content and the provision of 2D video contents are still common. Therefore, it is preferable to provide a technique for displaying 3D video and 2D video in a switched manner.

For example, JP-2007-213081-A (FIG. 4 and Paragraphs 0036 and 0037) discloses a technique relating to a 3D image display apparatus capable of displaying 2D video and 3D video in a switched manner. This technique can attain higher display quality and switching of higher speed than before and display a 2D image and a 3D image in a mixed manner in an arbitrarily selected area.

However, in JP-2007-110683-A, the opening/closing times of the electronic shutters are short. As a result, the luminance of displayed video is low and hence a 3D image can be displayed only in a restricted area of the screen. In the area where the 3D image cannot be displayed, information such as a logo and an explanation text relating to the 3D image is displayed as an on-screen display (OSD) image which is a graphic object. In other words, this OSD image is displayed as a non-3D image.

In JP-2007-213081-A, to display a 2D image and a 3D image in a switched manner, there are provided liquid crystal lenses as a birefringent lens array and a half-wave film or a ferroelectric liquid crystal cell as a birefringent phase modulating means. The lens effect of the birefringent lens array and the birefringent phase modulating means is controlled by a voltage. A 2D image and a 3D image are displayed in a switched manner by such a complex configuration. There is no disclosure as to a graphic object to be displayed combinedly with a 2D image or a 3D image.

That is, conventionally, although an input video signal can be displayed as 3D video or 2D video in a switched matter depending on the type of the input video signal, a graphic object that is not included in the input video signal cannot be displayed as 3D video or 2D video in the switched matter.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates an example configuration of a TV receiver according to a first embodiment.

FIG. 2 illustrates an example system block configuration according to the first embodiment for superimposing a 3D or 2D OSD image signal on an input video signal to display a resulting signal and controlling the 3D glasses.

FIG. 3 illustrates an example process for superimposing a 3D or 2D OSD image signal on an input video signal to display a resulting signal.

FIG. 4 illustrates an example 3D video signal.

FIG. 5 illustrates another example 3D video signal.

FIG. 6 illustrates an example image frame groups which are generated from an input 3D video signal through frame rate conversion and image frame rearrangement and are to be output to a display unit.

FIG. 7 illustrates an another image frame groups that are generated from an input 3D video signal through frame rate conversion and image frame rearrangement and are to be output to the display unit.

FIG. 8 illustrates an example timing chart for the output control of a 3D video signal to the display unit and the opening/closing control of shutters of the 3D glasses.

FIG. 9 illustrates an example system block configuration according to a modification of the first embodiment for superimposing a 3D or 2D OSD image signal on an input video signal to display a resulting signal and controlling the 3D glasses.

FIG. 10 illustrates an example system configuration according to a second embodiment for superimposing a 3D or 2D OSD image signal on an input video signal to display a resulting signal and controlling the 3D glasses.

FIG. 11 illustrates an example process for superimposing a 3D or 2D OSD image signal on an input video signal to display a resulting signal.

### DETAILED DESCRIPTION

Various embodiments according to the present invention will be described hereinafter with reference to the accompanying drawings. In general, according to one embodiment of the present invention, there is provided a video combining device including: a frame extraction module configured to extract, from a 3D video signal including a left-eye video signal and a right-eye video signal, left-eye frames and right-eye frames; a graphic object generation module configured to generate a left-eye object to be superimposedly displayed on a screen with the left-eye frames and to generate a right-eye object to be superimposedly displayed on the screen with the right-eye frames; a combined image generation module configured to generate combined left-eye frames by synchronizedly combining the left-eye object and the left-eye frames and to generate combined right-eye frames by synchronizedly combining the right-eye object and the right-eye frames; a frame group generation module configured to generate a left-eye frame group in which the number of frames is increased and a right-eye frame group in which the number of frames is increased by performing a frame interpolation based on the combined left-eye frames and the combined right-eye frames generated by the combined image generation module; and an image output module configured to alternately output the left-eye frame group and the right-eye frame group so as to sequentially rewrite a display on the screen so that the left-eye frame group and the right-eye frame group are alternately displayed on the screen.

### First Embodiment

A first embodiment of the present invention will be hereinafter described with reference to the drawings.

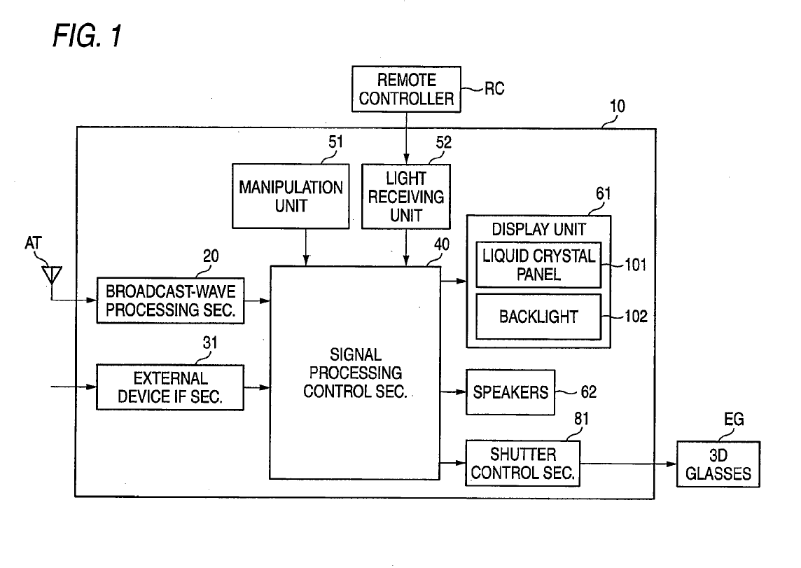

FIG. 1 illustrates the example configuration of a TV receiver 10 which is a video display apparatus incorporating a video combining device according to the first embodiment.

The TV receiver 10 according to the first embodiment includes a broadcast-wave processing section 20, an external device IF (interface) section 31, a signal processing control section 40, a manipulation unit 51, a light receiving unit 52, a display unit 61, speakers 62, a shutter control section 81, etc. The display unit 61 includes a liquid crystal panel 101, a backlight 102, etc. An antenna AT is connected to the broadcast-wave processing section 20. The light receiving unit 52 exchanges information with a remote controller RC, and the shutter control section 81 exchanges information with 3D glasses EG.

The TV receiver 10 acquires a signal of stereographic video (3D video) or ordinary non-stereographic video (2D video) which is supplied via the broadcast-wave processing section 20, the external device IF 31, or the like. The TV receiver 10 generates an OSD image signal for displaying a 3D or 2D graphic object (a text, a figure, etc.) according to the acquired 3D or 2D video signal, superimposes the generated OSD image signal on the acquired 3D or 2D video signal, and displays a resulting signal on the display unit 61. The TV receiver 10 controls the opening/closing of the shutters of the 3D glasses EG according to the acquired 3D or 2D video signal.

The broadcast-wave processing section 20 acquires signals of digital broadcast waves and analog broadcast waves received by the antenna AT, performs processing of tuning in to a signal on a particular channel of the acquired signals, performs demodulation and decoding processing on the selected signal, and outputs video data and audio data of a program, data to be used for generating an electronic program guide (EPG), and other data to the signal processing control section 40. In the first embodiment, the broadcast-wave processing section 20 acquires signals including a 3D video signal or a 2D video signal.

Through the external device IF 31, an external apparatus is connected to the TV receiver 10 via one of connection ports which comply with various standards such as the HDMI (trademark) standard, the USB standard, and the IEEE 1394 standard, acquires video data and audio data, data to be used for generating an EPG, and other data that are supplied from the connected external apparatus, and outputs the acquired data to the signal processing control section 40. Furthermore, to the external device IF 31, an external recording medium such as an external HDD or a memory card is connected to the TV receiver 10 via one of the connection ports which comply with the various standards such as the HDMI standard, the USB standard, and the IEEE 1394 standard and outputs or inputs video data and audio data etc. to or from the connected recording medium. Through the external device IF 31, a signal including a 3D video signal or a 2D video signal is acquired from an external device located outside the TV receiver 10.

The manipulation unit 51 receives manipulation input information to be used for manipulating the TV receiver 10 and outputs it to the signal processing control section 40. Likewise, the light receiving section 52 optically receives the manipulation input information from the remote controller RC and outputs it to the signal processing control section 40.

The signal processing control section 40 performs various kinds of processing such as expansion of compressed data and data extraction processing for generating an EPG on a signal acquired from the broadcast-wave processing section 20, the external IF section 31, or the like according to manipulation input information received from the manipulation unit 51 or the light receiving unit 52. The signal processing control section 40 performs various kinds of processing such as MPEG coding/decoding processing and processing of separating a video signal and an audio signal on the received signal (data) and outputs a video signal and an audio signal to the display unit 61 and the speakers 62, respectively. The signal processing control section 40, which has a CPU, controls execution of plural pieces of processing using modules that are provided in or connected to the signal processing control section 40.

In the first embodiment, the signal processing control section 40 performs prescribed processing on a signal including a 3D video signal or a 2D video signal acquired from the broadcast-wave processing section 20 or the external device IF 31, or the like and displays 3D video or 2D video on the display unit 61. The signal processing control section 40 generates a 3D or 2D OSD image signal according to the acquired 3D or 2D video signal, superimposes the generated OSD image signal on the acquired 3D or 2D video signal, and displays a resulting signal on the display unit 61. The signal processing control section 40 outputs, to the shutter control section 81, information for the opening/closing control of the shutters of the 3D glasses EG according to the acquired 3D or 2D video signal.

The display unit 61 is a display module for displaying a video signal received from the signal processing control section 40 and is, for example, a flat display such as an LCD (liquid crystal display). The display unit 62 displays a video signal received from the signal processing control section 40 on a liquid crystal panel 101. The liquid crystal panel 101 is a light-transmission-type video display panel and turns on or off the backlight 102 according to a control signal supplied from the signal processing control section 40. Although an LCD is exemplified as the display unit 61, the embodiment is not limited thereto.

In the liquid crystal panel 101, plural pixels are arranged in a matrix of a prescribed size. The liquid crystal panel 101 displays video by sequentially rewriting the display on the screen by performing scans along prescribed scanning lines according to a video signal received from the signal processing control section 40.

The backlight 102 illuminates the liquid crystal panel 101 from its back side as a light source. A direct facing type cold cathode fluorescent tube or a direct facing type or side illumination type EL (electroluminescence) device(s) or LEDs may be used as the backlight 102. In the first embodiment, the backlight 102 is a direct facing type or side illumination type LED light source and is turned on/off according to control information supplied from the signal processing control section 40.

The speakers 62 output a sound according to an audio signal that is received from the signal processing control section 40.

The shutter control section 81 outputs shutter control signals for the opening/closing control of the left-eye shutter and the right-eye shutter of the 3D glasses EG according to information received from the signal processing control section 40. Although the shutter control section 81 is exemplified as being provided separately from the signal processing control section 40, it may be incorporated in the signal processing control section 40.

Although the TV receiver 10 is exemplified, the embodiment can also be applied to an HDD recorder, a DVD recorder, a personal computer, a cell phone, or the like including the same configuration as described in the first embodiment. The embodiment can further be applied to, for example, a set top box configured to receive not only TV broadcasts including satellite broadcasts but also radio broadcasts, cable broadcasts using the Internet or the like, and other broadcasts.

Having the above example configuration, the TV receiver 10 acquires a 3D or 2D video signal, generates a 3D or 2D OSD image signal according to the acquired 3D or 2D video signal, superimposes the generated OSD image signal on the acquired 3D or 2D video signal, and displays a resulting signal on the display unit 61. The TV receiver 10 controls the opening/closing of the shutters of the 3D glasses EG according to the acquired 3D or 2D video signal.

The signal processing control section 40 performs the above processing, based on a video signal acquired from the broadcast-wave processing section 20, the external device IF section 31, or the like.

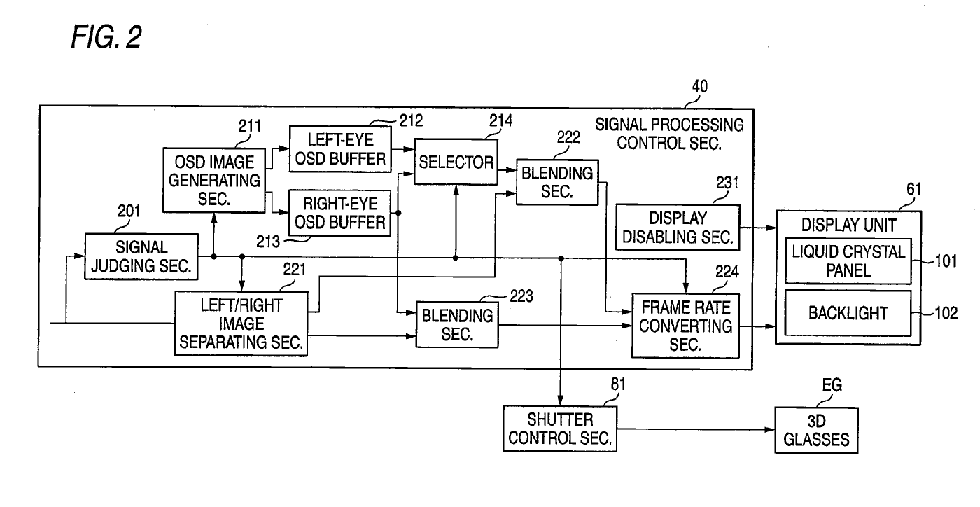

Next, individual blocks, which are mainly provided in the signal processing control section 40 shown in FIG. 1, to perform processing of superimposing a 3D or 2D OSD image signal on an input video signal depending on the type of the input video signal to display a resulting signal and processing of controlling the 3D glasses EG will be described with reference to FIG. 2.

FIG. 2 illustrates the example system block configuration according to the first embodiment for superimposing a 3D or 2D OSD image signal on an input video signal to display a resulting signal and controlling the 3D glasses EG.

The system configuration of FIG. 2 provides a video combining device. The video combining device may be provided separately from the signal processing control section 40.

The signal processing control section 40 according to the first embodiment includes a signal judging section 201, an OSD image generating section 211, a left-eye OSD buffer 212, a right-eye OSD buffer 213, a selector 214, a left/right image separating section 221, blending sections 222 and 223, a frame rate converting section 224, a display disabling section 231, etc.

The signal judging section 201 judges whether an input video signal is of 3D video or 2D video and outputs a judgment result to other blocks. For example, the judgment may be made based on information indicating a type of a video signal that is supplied from an external apparatus connected to the HDMI-compatible connection port via the external device IF section 31. More specifically, the information referred for the judgment may be acquired through a negotiation of a connection authentication when the HDMI-compatible external apparatus is connected, in accordance with a protocol of 3D video data transfer defined in version 1.4 of the HDMI standard.

The signal judging section 201 can also make a judgment by detecting whether or not an input video signal supplied from the broadcast-wave processing section 20, the external device IF section 31, or the like has a feature of 3D video by performing one or plural ones (in a composite manner) of detection of 3D content identification information contained in information relating to coding of the input video signal, detection of an image format that is unique to 3D video of, for example, the side-by-side method which utilizes a parallax between the two eyes, and other kinds of detection. Thus, the judging method is not limited to a particular one.

If the signal judging section 201 judges that the input video signal is of 3D video, the OSD image generating section 211 generates a left-eye OSD image signal and a right-eye OSD image signal and outputs them to the left-eye OSD buffer 212 and the right-eye OSD buffer 213, respectively. If the signal judging section 201 judges that the input video signal is of 2D video, the OSD image generating section 211 generates a 2D OSD image signal and outputs it to the right-eye OSD buffer 213.

If the signal judging section 201 judges that the input video signal is of 3D video, the left-eye OSD buffer 212 stores the left-eye OSD image signal that is input from the

OSD image generating section 211 and outputs it to the selector 214 with prescribed timing. If the signal judging section 201 judges that the input video signal is of 2D video, the left-eye OSD buffer 212 stores nothing because no signal is input from the OSD image generating section 211.

The right-eye OSD buffer 213 stores the right-eye OSD image signal corresponding to the 3D video or the 2D OSD image signal corresponding to the 2D video that is input from the OSD image generating section 211, and outputs it to the selector 214 and the blending section 223 with prescribed timing.

If the signal judging section 201 judges that the input video signal is of 3D video, the selector 214 is set to output, to the blending section 222, the left-eye OSD image signal that is input from the left-eye OSD buffer 212. On the other hand, if the signal judging section 201 judges that the input video signal is of 2D video, the selector 214 is set to output, to the blending section 222, the 2D OSD image signal that is input from the right-eye OSD buffer 213.

If the signal judging section 201 judges that the input video signal is of 3D video, the left/right image separating section 221 separates the input 3D video signal into two sets of image frames by extracting a left-eye video signal (left-eye image frames) and a right-eye video signal (right-eye image frames) from the image frames of the input 3D video signal by performing prescribed processing on a frame-by-frame basis and outputs the two sets of image frames to the respective blending sections 222 and 223. The left-eye video signal and the right-eye video signal are multiplexed according to an encoding method such as a method in which they are assigned to odd-numbered scanning lines and even-numbered scanning lines, respectively, or a method in which they are assigned to a left-hand area and a right-hand area of each image frame, respectively. Or the left-eye video signal and the right-eye video signal are multiplexed according to an encoding method such as a method in which square areas each having a prescribed number of pixels are arranged in a checkered manner or a method in which left-eye image frames and right-eye image frames are arranged alternately in a time-divisional manner.

On the other hand, if the signal judging section 201 judges that the input video signal is of 2D video, the left/right image separating section 221 does not separate the input 2D video signal because it does not contain a left-eye video signal and a right-eye video signal. Instead, the left/right image separating section 221 extracts 2D image frames from the input video signal and outputs them to each of the blending sections 222 and 223.

If the signal judging section 201 judges that the input video signal is of 3D video, the blending section 222 generates new left-eye image frames by combining (superimposing) the left-eye OSD image signal that is input from the left-eye OSD buffer 212 via the selector 214 with (on) the left-eye video signal that is input from the left/right image separating section 221 and outputs the generated left-eye image frames to the frame rate converting section 224. The blending section 223 generates new right-eye image frames by combining (superimposing) the right-eye OSD image signal that is input from the right-eye OSD buffer 213 with (on) the right-eye video signal that is input from the left/right image separating section 221 and outputs the generated right-eye image frames to the frame rate converting section 224.

If the signal judging section 201 judges that the input video signal is of 2D video, the blending section 222 generates new 2D image frames by combining (superimposing) the 2D OSD image signal that is input from the right-eye OSD buffer 213 via the selector 214 with (on) the 2D image frames that are input from the left/right image separating section 221 and outputs the generated 2D image frames to the frame rate converting section 224. The blending section 223 generates new 2D image frames by combining (superimposing) the 2D OSD image signal that is input from the right-eye OSD buffer 213 with (on) the 2D image frames that are input from the left/right image separating section 221 and outputs the generated 2D image frames to the frame rate converting section 224.

That is, the blending section 222 and the blending section 223 operate in a similar manner for both the 3D video and the 2D video.

If the signal judging section 201 judges that the input video signal is of 3D video, the frame rate converting section 224 generates a left-eye image frame group from the left-eye image frames input from the blending section 222 by adding (a prescribed number of) interpolation frames. Likewise, the frame rate converting section 224 generates a right-eye image frame group from the right-eye image frames input from the blending section 223 by adding interpolation frames.

The left-eye image frame group and the right-eye image frame group generated by adding the interpolation frames have more image frames than the left-eye image frames that are input from the blending section 222 and the right-eye image frames that are input from the, blending section 223, respectively. That is, the frame rate converting section 224 performs conversions so that the frame interval is shortened (i.e., the frame rate is increased). The frame rate converting section 224 outputs the image frames of the generated left-eye image frame group and right-eye image frame group to the display unit 61 in prescribed order and causes the display unit 61 to display them.

On the other hand, if the signal judging section 201 judges that the input video signal is of 2D video, the frame rate converting section 224 selects one of the two image frames that are input from the respective blending sections 222 and 223 and adds (a prescribed number of) interpolation frames based on the selected image frame. The frame rate converting section 224 thus generates a frame-interpolated 2D image frame group. The frame rate converting section 224 outputs the generated 2D image frames to the display unit 61 in prescribed order and causes the display unit 61 to display them.

If the signal judging section 201 judges that the input video signal is of 3D video, the display disabling section 231 turns off the backlight 102 with prescribed timing to not display a corresponding image frame on the display unit 61, or send a non-display video signal to the liquid crystal panel 101 with prescribed timing so that display is not made on the display unit 61. If the signal judging section 201 judges that the input video signal is of 2D video, basically, the display disabling section 231 controls the display unit 61 so as to enable display of an image frame. However, the display disabling section 231 may control the display unit 61 so as to disable display with prescribed timing to prevent a so-called motion blur.

If the signal judging section 201 judges that the input video signal is of 3D video, the shutter control section 81 outputs, to the 3D glasses EG, shutter control signals for opening the left-eye shutter and the right-eye shutter of the 3D glasses EG alternately in synchronism with the output of the left-eye and right-eye image frames from the frame rate converting section 224. If the signal judging section 201 judges that the input video signal is of 2D video, the shutter control section 81 outputs, to the 3D glasses EG, shutter control signals for opening the left-eye shutter and the right-eye shutter of the 3D glasses EG all the time.

Most of the blocks shown in FIG. 2 need to operate in synchronism with each other according to a prescribed timing scheme so that as described above the shutter control section outputs shutter control signals for opening/closing the shutters with the same timing as the frame rate converting section 224 outputs image frames. In the first embodiment, it is preferable that the individual blocks shown in FIG. 2 operate in synchronism with each other according to a prescribed timing scheme being controlled by a prescribed sync signal which is managed by the shutter control section 81 based on a timing scheme according which the left/right image separating section 221 outputs image frames. Instead of the shutter control section 81, another block may manage the prescribed sync signal.

In the system configuration of FIG. 2, the “left” and the “right” may be interchanged. More specifically, where an input video signal is of 3D video, opposite OSD image signals (i.e., opposite to the OSD image signals in the system configuration of FIG. 2) may be stored in the (right-eye) OSD buffer 212 and the (left-eye) OSD buffer 213. The left/right image separating section 221 may output opposite video signals to the blending sections 222 and 223, and the frame rate converting section 224 may receive opposite sets of image frames from the blending sections 222 and 223. The “left” and the “right” can be also interchanged for the other blocks.

The system configuration of FIG. 2 may be modified so that the left/right image separating section 221 outputs an input 2D video signal to one of the blending sections 222 and 223 if the signal judging section 201 judges that the input video signal is of 2D video. In this configuration, the frame rate converting section 224 selects a signal that is input from the one of the blending sections 222 and 223 that receives the input 2D video signal. The other of the blending sections 222 and 223 need not receive the OSD image signal or output the OSD image signal even if it is received.

The selector 214 may be provided between the right-eye OSD buffer 213 and the blending section 223 rather than between the left-eye OSD buffer 212 and the blending section 222.

With the above example system configuration, the signal processing control section 40 performs processing of superimposing a 3D or 2D OSD image signal on an input video signal to display a resulting signal and processing of controlling the 3D glasses EG.

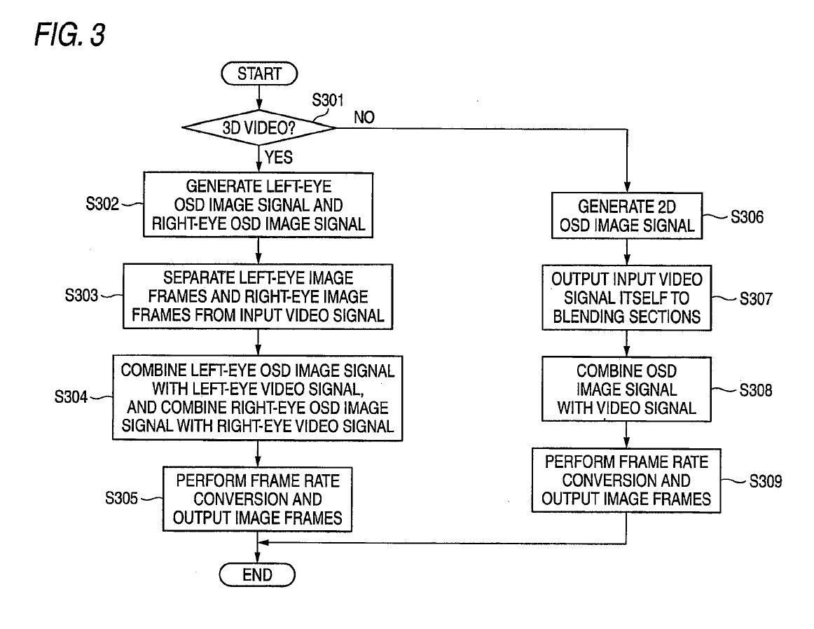

Next, a process which is executed by the above-described blocks to superimpose a 3D or 2D OSD image signal on an input video signal and display a resulting signal will be described with reference to FIG. 3.

FIG. 3 illustrates the example process for superimposing a 3D or 2D OSD image signal on an input video signal to display a resulting signal.

First, at step S301, the signal judging section 210 judges whether an input video signal is of 3D video or 2D video. If the signal judging section 201 judges that the input video signal is of 3D video (S301: yes), at step S302 the OSD signal generating section 211 generates a left-eye OSD image signal and a right-eye OSD image signal and outputs them to the left-eye OSD buffer 212 and the right-eye OSD buffer 213, respectively.

At step S303, the, left/right image separating section 221 extracts (separates) a left-eye video signal and a right-eye video signal from the image frames of the input 3D video signal and outputs the extracted signals to the respective blending sections 222 and 223.

At step S304, the blending section 222 generates new left-eye image frames by combining (superimposing) the left-eye OSD image signal that is input from the left-eye OSD buffer 212 via the selector 214 with (on) the extracted left-eye video signal according to a prescribed timing scheme and outputs the generated left-eye image frames to the frame rate converting section 224. The blending section 223 generates new right-eye image frames by combining (superimposing) the right-eye OSD image signal that is input from the right-eye OSD buffer 213 with (on) the separated right-eye video signal according to a prescribed timing scheme and outputs the generated right-eye image frames to the frame rate converting section 224. The selector 214 is set to output the left-eye OSD image signal to the blending section 222.

At step S305, the frame rate converting section 224 alternately arrange the image frames of left-eye image frame group generated based on the left-eye image frames received from the blending section 222 and the image frames of right-eye image frame group generated based on the right-eye image frames received from the blending section 223, and outputs resulting image frames to the display unit 61 in prescribed order to cause the display unit 61 to display those image frames.

On the other hand, if the signal judging section 201 judges that the input video signal is of 2D video (S301: no), at step S306 the OSD image generating section 211 generates a 2D OSD image signal and outputs it to the right-eye OSG buffer 213. At step S307, the left/right image separating section 221 does not separate the input video signal and outputs its 2D image frames to each of the blending sections 222 and 223.

At step S308, the blending section 222 generates new 2D image frames by combining (superimposing) the 2D OSD image signal that is input from the right-eye OSD buffer 213 via the selector 214 with (on) the input video signal that is input from the left/right image separating section 221 according to a prescribed timing scheme and outputs the generated 2D image frames to the frame rate converting section 224. The blending section 223 generates new 2D image frames by combining (superimposing) the 2D OSD image signal that is input from the right-eye OSD buffer 213 with (on) the input video signal that is input from the left/right image separating section 221 according to a prescribed timing scheme and outputs the generated 2D image frames to the frame rate converting section 224. The selector 214 is set to output the right-eye OSD image signal to the blending section 222.

At step S309, the frame rate converting section 224 outputs the image frames of 2D image frame groups generated based on one of the two sets of image frames that are input from the blending sections 222 and 223 to the display unit 61 in prescribed order to cause the display unit 61 to display those image frames.

In the above-described manner, the blocks provided in the signal processing control section 40 etc. according to the first embodiment generate an OSD image signal corresponding to an input video signal depending on whether the input video signal is of 3D video or 2D video, superimposes the generated 3D or 2D OSD image signal on the input video signal, and displays a resulting signal.

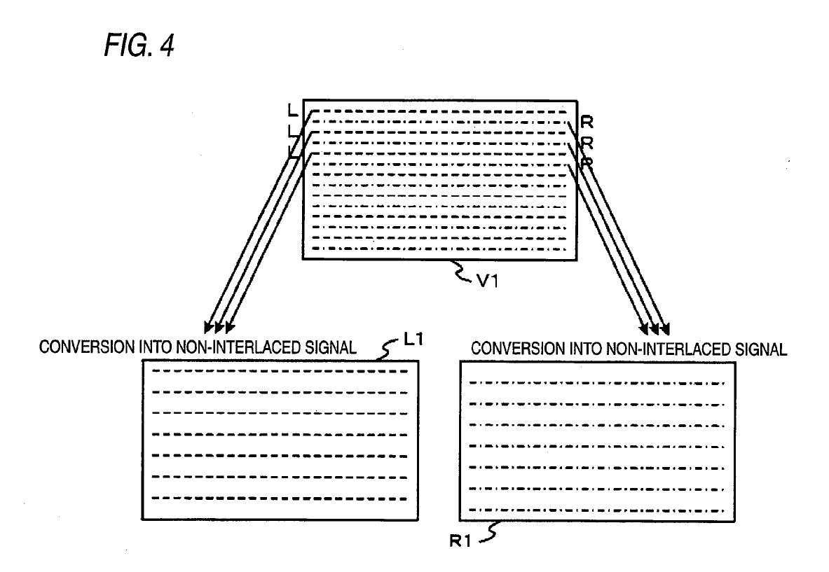

Next, a process for displaying input 3D video, which is to be executed by the above-described blocks as a base of the process for superimposing a 3D or 2D OSD image signal on an input video signal to display a resulting signal, will be described with reference to FIGS. 4-8.

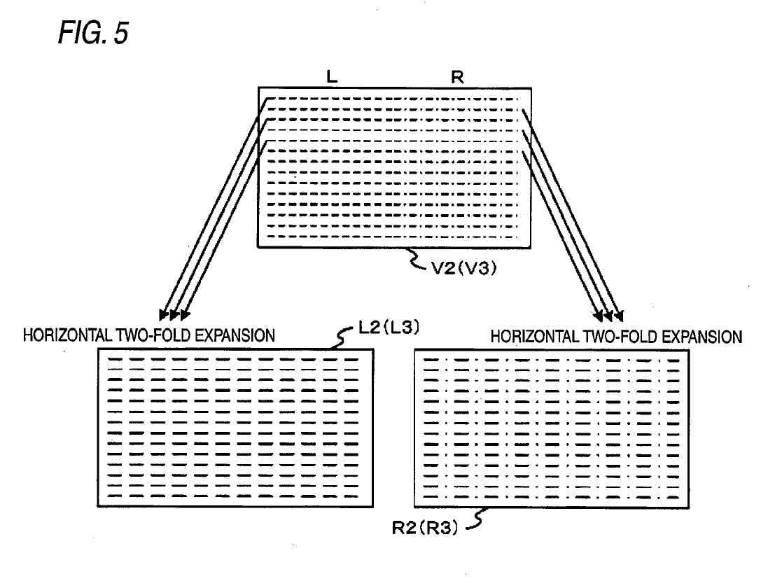

First, specific examples of a 3D video signal which is input to the signal judging section 201 and the left/right image separating section 221 will be described with reference to FIGS. 4 and 5. FIGS. 4 and 5 show specific examples of a 3D video signal.

More specifically, an image frame V1 of a 3D video signal shown in FIG. 4 is such that a left-eye video signal and a right-eye video signal are multiplexed together according to an encoding method of alternately arranging scanning line portions of a left-eye video signal L and scanning line portions of a right-eye video signal R. The left/right image separating section 221 separates the input image frame V1 into two image frames by extracting, from the input image frame V1, a left-eye image frame L1 obtained by converting the left-eye video signal L into a non-interlaced signal and a right-eye image frame R1 obtained by converting the right-eye video signal R into a non-interlaced signal.

An image frame V2 (V3) of a 3D video signal shown in FIG. 5 is such that a left-eye video signal and a right-eye video signal are multiplexed together according to an encoding method of arranging a left-eye video signal L and a right-eye video signal R in a left-hand area and a right-hand area, respectively, of one image frame. The left/right image separating section 221 separates the input image frame V2 (V3) into two image frames by extracting, from the input image frame V2 (V3), a left-eye image frame L2 (L3) obtained by expanding the left-eye video signal L in the horizontal direction by a factor of two and a right-eye image frame R2 (R3) obtained by expanding the right-eye video signal R in the horizontal direction by a factor of two.

If a left-eye video signal and a right-eye video signal are multiplexed together according to an encoding method of arranging square areas each having a prescribed number of pixels in checkered manner (not shown), a left-eye image frame and a right-eye image frame are extracted by processing that is similar to the processing for the 3D video signal shown in FIG. 5.

In the case of such an encoding method as a method of arranging left-eye image frames and right-eye image frames alternately in a time-divisional manner (not shown), both of a left-eye image frame and a right-eye image frame are not extracted from one image frame. Instead, a left-eye image frame and a right-eye image frame are extracted from each set of image frames.

Information relating to a 3D video signal encoding method such as the encoding method of FIG. 4 or 5 is contained in information relating to a connection authentication that is performed with an external apparatus that complies with the HDMI standard or information relating to coding of an input video signal. The signal judging section 201 can judge whether an input video signal is of 3D video or not using such information.

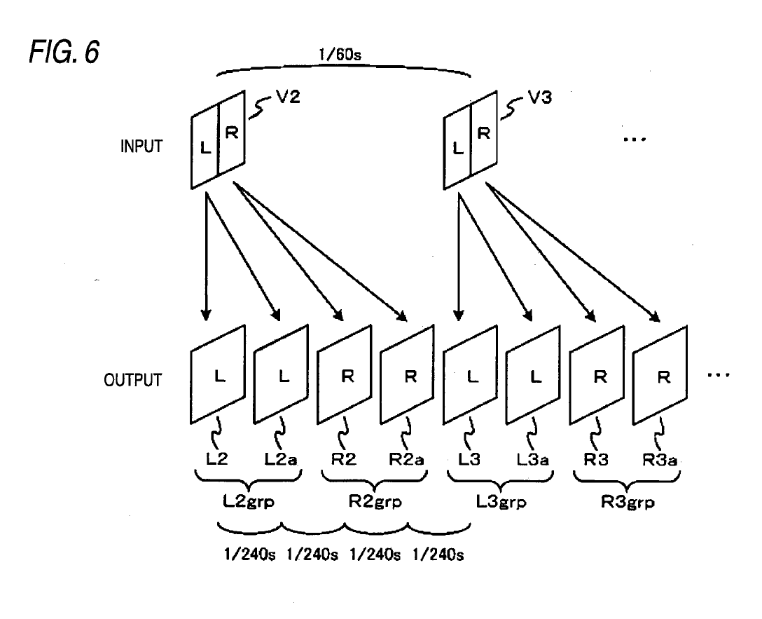

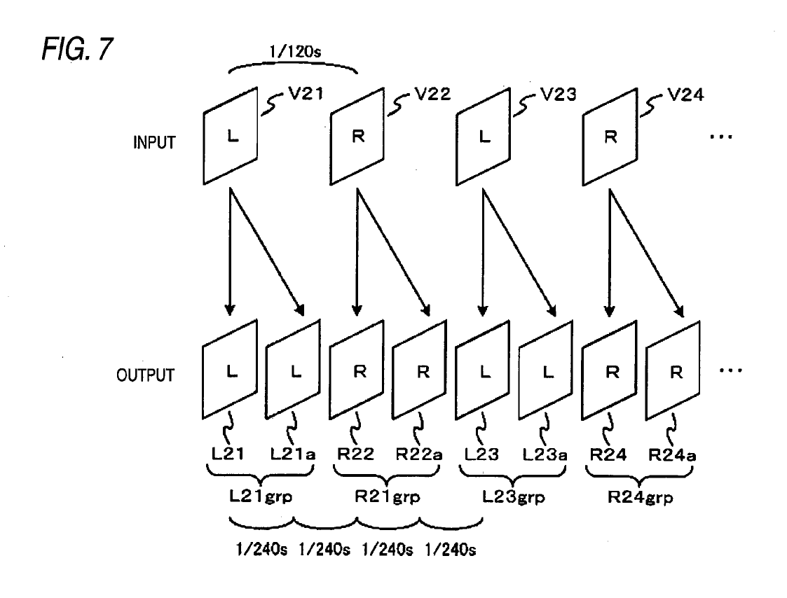

Next, specific examples of a set of image frames that are generated from a 3D video signal that is input to the signal judging section 201 and the left/right image separating section 221 (described above with reference to FIG. 2) through frame rate conversion and image frame rearrangement and are to be output to the display unit 61 will be described with reference to FIGS. 6 and 7.

FIGS. 6 and 7 illustrate specific examples of a set of image frames that are generated from an input 3D video signal through frame rate conversion and image frame rearrangement and are to be output to the display unit 61.

More specifically, FIG. 6 shows a specific example of image frame groups that are generated from the 3D video signal of FIG. 5 and are to be output to the display unit 61. Image frames V2 and V3 in each of which a left-eye video signal L and a right-eye video signal R are multiplexed together as shown in FIG. 6 are input at frame intervals of 1/60 s (frame rate: 60 f/s).

A left-eye image frame L2 and a right-eye image frame R2 that are extracted (separated) from the image frame V2 are subjected to prescribed processing in the respective blending sections 222 and 223 and input to the frame rate conversion section 224. The frame rate conversion section 224 generates an image frame L2a (interpolation frame) based on the received left-eye image frame L2 and thereby generates a left-eye image frame group L2grp including the image frames L2 and L2a. Likewise, the frame rate conversion section 224 generates an image frame R2a (interpolation frame) based on the received right-eye image frame R2 and thereby generates a right-eye image frame group R2grp including the image frames R2 and R2a.

Although in the above example one left-eye interpolation frame and one right-eye interpolation frame are generated, more interpolation frames may be generated, that is, the number of generated interpolation frames is not limited to any number. An interpolation frame may be generated either by copying an original image frame or by interpolating a frame by performing prescribed processing also using an immediately preceding or following image frame for each of a left-eye and right-eye image frames.

The frame rate converting section 224 arranges the left-eye image frame group L2grp and the right-eye image frame group R2grp alternately in a time-divisional manner, and outputs their image frames sequentially to the display unit 61 to cause the display unit 61 to display them.

More specifically, the frame rate converting section 224 sequentially outputs the image frames L2, L2a, R2, and R2a to the display unit 61 in this order. The same processing is performed on the image frame V3, whereby a left-eye image frame group L3grp including image frames L3 and L3a and the right-eye image frame group R3grp including image frames R3 and R3a are generated. The frame rate converting section 224 sequentially outputs the image frames L3, L3a, R3, and R3a to the display unit 61 in this order.

As described above, the frame rate converting section 224 generates a group of two left-eye image frames and a group of two right-eye image frames from each image frame of an input 3D video signal, arranges the two kinds of groups alternately in a time-divisional manner, and outputs resulting image frames to the display unit 61 sequentially. As a result, the original frame interval 1/60 s is converted into a frame interval 1/240 s (frame rate: 240 f/s).

In a 3D video signal shown in FIG. 7, left-eye image frames V21 and V23 (left-eye image signal) and right-eye image frames V22 and V24 (right-eye image signal) are input alternately at frame intervals of 1/120 s (frame rate: 120 f/s).

When the above 3D video signal is input, the frame rate converting section 224 generates, from the received left-eye image frame V21, a left-eye image frame group L21grp including image frames L21 (V21) and L21a, and generates, from the received right-eye image frame V22, a right-eye image frame group R22grp including image frames R22 (V22) and R22a. The frame rate converting section 224 outputs the image frames L21, L21a, R22, and R22a to the display unit 61 in this order. The same processing is performed on the image frames V23 and V24, whereby image frames L23, L23a, R24, and R24a are output to the display unit 61 in this order.

As described above, in the case of the 3D video signal as shown in FIG. 7 which has a frame interval of 1/120 s, the frame rate converting section 224 arranges two image frames for each of left-eye image frames and right-eye image frames that are received alternately and outputs resulting image frames sequentially to the display unit 61. As a result, the original frame interval 1/120 s is converted into a frame interval 1/240 s.

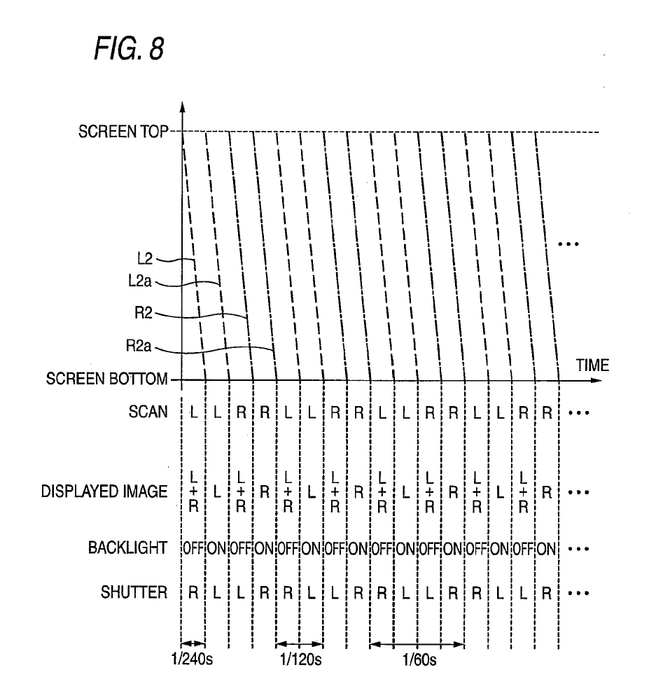

Next, a timing scheme for the control of the output of a 3D video signal to the display unit 61 and the opening/closing of the shutters of the 3D glasses EG will be described with reference to FIG. 8.

FIG. 8 illustrates the example timing chart for the output control of a 3D video signal to the display unit 61 and the opening/closing control of the shutters of the 3D glasses EG.

As shown in FIG. 8, the image frames that are input from the frame rate converting section 224 are rewritten sequentially as the scanning lines of the display panel 101 are scanned downward. In synchronism with the image frame rewriting on the display panel 101, the display disabling section 231 enable or disable the display and the shutter control section 81 controls the opening/closing of the shutters of the 3D glasses EG. As a result, the user of the TV receiver 10 can visually recognize 3D video displayed on the screen through the 3D glasses EG.

More specifically, in the scanning period of the left-eye image frame L2, the immediately preceding, right-eye frame image R is rewritten to the left-eye image frame L2 and hence an image R+L2 which is a mixture of the right-eye frame image R and the left-eye image frame L2 is displayed. In this period, to disable display, the display disabling section 231 controls the backlight 102 so as to turn it off. The shutter control section 81 controls the shutters so as to close the left-eye shutter and open the right-eye shutter. Alternatively, the shutter control section 81 may control the shutters in an opposite manner so as to open the left-eye shutter and close the right-eye shutter or control the shutters so as to close both of the left-eye shutter and the right-eye shutter.

In the scanning period of the left-eye image frame L2a, the immediately preceding, left-eye frame image L2 is rewritten to the left-eye image frame L2a and hence an image L2+L2a which is a mixture of the left-eye image frames L2 and L2a is displayed. In this period, to enable display, the display disabling section 231 controls the backlight 102 so as to turn it on. The shutter control section 81 controls the shutters so as to open the left-eye shutter and close the right-eye shutter.

In the scanning period of the right-eye image frame R2, the immediately preceding, left-eye frame image L2a is rewritten to the right-eye image frame R2 and hence an image L2a+R2 which is a mixture of the left-eye frame image L2a and the right-eye image frame R2 is displayed. In this period, to disable display, the display disabling section 231 controls the backlight 102 so as to turn it off. The shutter control section 81 controls the shutters so as to open the left-eye shutter and close the right-eye shutter. Alternatively, the shutter control section 81 may control the shutters in an opposite manner so as to close the left-eye shutter and open the right-eye shutter or control the shutters so as to close both of the left-eye shutter and the right-eye shutter.

In the scanning period of the right-eye image frame R2a, the immediately preceding, right-eye frame image R2 is rewritten to the right-eye image frame R2a and hence an image R2+R2a which is a mixture of the right-eye image frames R2 and R2a is displayed. In this period, to enable display, the display disabling section 231 controls the backlight 102 so as to turn it on. The shutter control section 81 controls the shutters so as to close the left-eye shutter and open the right-eye shutter.

As described above, the display disabling section 231 disables display during periods of rewriting from a left-eye image frame to a right-eye image frame or vice versa. On the other hand, the display disabling section 231 enables display during periods of rewriting from a left-eye (or right-eye) image frame to the next left-eye (or right-eye) image frame. And the shutter control section 81 controls the shutters so as to open the corresponding left-eye or right-eye shutter during periods when only left-eye or right-eye image frames are displayed on the screen (i.e., a left-eye image frame and a right-eye image frame are not displayed in mixture). This operation prevents display of video that is impaired in 3D sense.

(Modification)

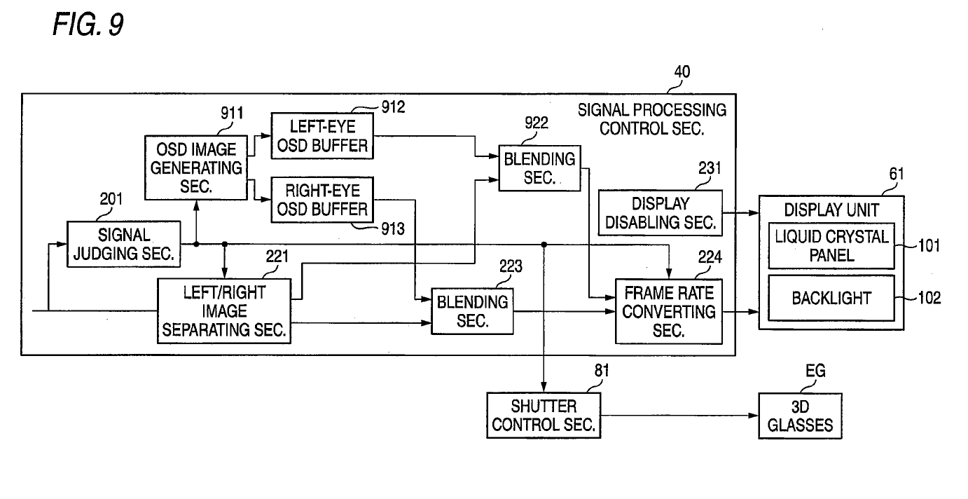

Next, modified blocks which perform processing of superimposing a 3D or 2D OSD image signal on an input video signal depending on the type of the input video signal to display a resulting signal and processing of controlling the 3D glasses EG will be described with reference to FIG. 9.

FIG. 9 illustrates the example system block configuration according to a modification of the first embodiment for superimposing a 3D or 2D OSD image signal on an input video signal to display a resulting signal and controlling the 3D glasses EG.

A signal processing control section 40 according to the modification of the first embodiment includes a signal judging section 201, an OSD image generating section 911, a left-eye OSD buffer 912, a right-eye OSD buffer 913, a left/right image separating section 221, blending sections 922 and 223, a frame rate converting section 224, a display disabling section 231, etc.

The system configuration of FIG. 9 also provides a video combining device. The video combining device may be provided separately from the signal processing control section 40.

Although the system according to the modification performs approximately the same processing as that of FIG. 2, the selector 214 is not provided and the left-eye OSD buffer 912 is directly connected to the blending section 922. In operation, the OSD image generating section 911 outputs a prescribed OSD signal(s) to the left-eye OSD buffer 912 and the right-eye OSD buffer 913 depending on the judgment result of the signal judging section 201.

Because of the above differences, the OSD image generating section 911, the left-eye OSD buffer 912, the right-eye OSD buffer 913, and the blending section 922 operate differently than the OSD image generating section 211, the left-eye OSD buffer 212, the right-eye OSD buffer 213, and the blending section 222 shown in FIG. 2. The other blocks operate in the same manners as the corresponding blocks shown in FIG. 2, and hence are given the same reference numerals as the latter and will not be described in detail. Therefore, in the following, the OSD image generating section 911, the left-eye OSD buffer 912, the right-eye OSD buffer 913, and the blending section 922 will be described in detail.

If the signal judging section 201 judges that an input video signal is of 3D video, the OSD image generating section 911 generates a left-eye OSD image signal and a right-eye OSD image signal and outputs them to the left-eye OSD buffer 212 and the right-eye OSD buffer 213, respectively. If the signal judging section 201 judges that the input video signal is of 2D video, the OSD image generating section 911 generates a 2D OSD image signal and outputs it to the left-eye OSD buffer 912 and the right-eye OSD buffer 913.

The left-eye OSD buffer 912 stores the left-eye OSD image signal corresponding to the 3D video or the 2D OSD image signal corresponding to the 2D video that is input from the OSD image generating section 911, and outputs it to the blending section 922 with prescribed timing.

The right-eye OSD buffer 913 stores the right-eye OSD image signal corresponding to the 3D video or the 2D OSD image signal corresponding to the 2D video that is input from the. OSD image generating section 911, and outputs it to the blending section 923 with prescribed timing.

If the signal judging section 201 judges that the input video signal is of 3D video, the blending section 922 generates new left-eye image frames by combining (superimposing) the left-eye OSD image signal that is input from the left-eye OSD buffer 912 with (on) a left-eye video signal that is input from the left/right image separating section 221 and outputs the generated left-eye image frames to the frame rate converting section 224. If the signal judging section 201 judges that the input video signal is of 2D video, the blending section 922 generates new 2D image frames by combining (superimposing) the 2D OSD image signal that is input from the left-eye OSD buffer 912 with (on) the 2D image signal that is input from the left/right image separating section 221 and outputs the generated 2D image frames to the frame rate converting section 224.

In the system configuration of FIG. 9, the “left” and the “right” may be interchanged. More specifically, where an input video signal is of 3D video, opposite OSD image signals (i.e., opposite to the OSD image signals in the system configuration of FIG. 9) are stored in the (right-eye) OSD buffer 912 and the (left-eye) OSD buffer 913. The left/right image separating section 221 outputs opposite video signals to the blending sections 922 and 223, and the frame rate converting section 224 receives opposite sets of image frames from the blending sections 922 and 223. The “left” and the “right” can be also interchanged for the other blocks.

The system configuration of FIG. 9 may be modified so that the left/right image separating section 221 outputs the input 2D video signal to one of the blending sections 922 and 223 if the signal judging section 201 judges that the input video signal is of 2D video. In this configuration, the frame rate converting section 224 selects a signal that is input from the one of the blending sections 922 and 223 that receives the input 2D video signal. The other of the blending sections 922 and 223 need not receive the OSD image signal or output the OSD image signal even if it is received. The left-eye OSD buffer 912 or the right-eye OSD buffer 913 that corresponds to the other of the blending sections 922 and 223 need not store the OSD image signal.

With the above example system configuration, as the first embodiment, the signal processing control section 40 performs processing of superimposing a 3D or 2D OSD image signal on an input video signal to display a resulting signal and processing of controlling the 3D glasses EG.

As described above, in the first embodiment, in the process for superimposing a 3D or 2D OSD image signal on an input video signal to display a resulting signal, a 3D or 2D OSD image signal is generated according to the type of an input video signal. A 3D OSD image signal is superimposed on a 3D video signal and a 2D OSD image signal is superimposed on a 2D image signal. Image frame groups each consisting of a prescribed number of image frames are generated from image frames in which OSD images corresponding to the input video signal are incorporated, and displayed on the display unit 61 in prescribed order. The opening/closing of the shutters of the 3D glasses EG is also controlled in a manner depending on the type of the input video signal.

### Second Embodiment

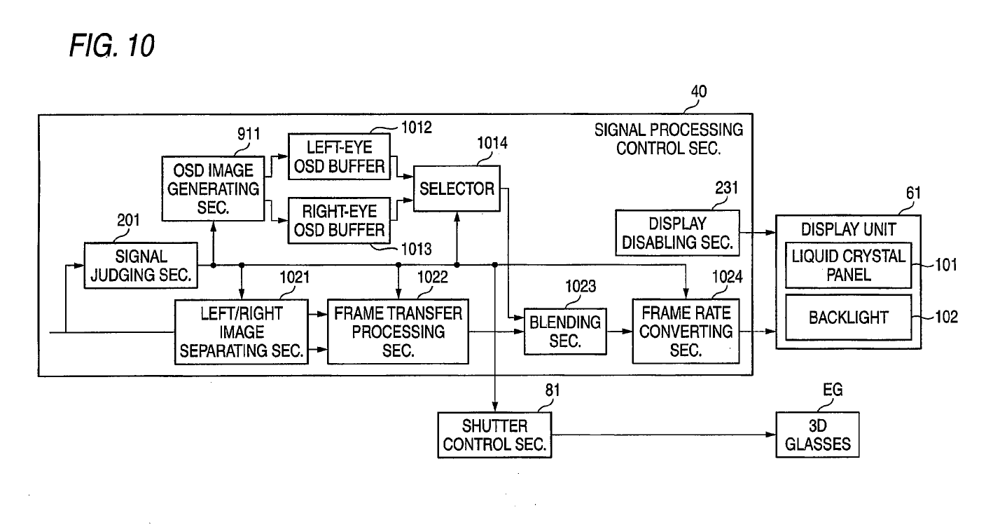

Next, a system configuration according to a second embodiment for superimposing a 3D or 2D OSD image signal on an input video signal to display a resulting signal will be described with reference to FIG. 10.

FIG. 10 illustrates the example system block configuration according to the second embodiment for superimposing a 3D or 2D OSD image signal on an input video signal to display a resulting signal and controlling the 3D glasses EG.

A signal processing control section 40 according to the second embodiment includes a signal judging section 201, an OSD image generating section 911, a left-eye OSD buffer 1012, a right-eye OSD buffer 1013, a selector 1014, a left/right image separating section 1021, a frame transfer processing section 1022, a blending sections 1023, a frame rate converting section 1024, a display disabling section 231, etc.

The system configuration of FIG. 10 also provides a video combining device. The video combining device may be provided separately from the signal processing control section 40.

Although the system according to the embodiment operates approximately in the same manner as the systems according to the first embodiment and its modification, several blocks having corresponding blocks in FIG. 2 or 9 operate differently than the latter. Therefore, in the following, the blocks that operate differently than the corresponding blocks in FIG. 2 or 9 will mainly be described in detail. The other blocks that operate in the same manners as the corresponding blocks in FIG. 2 or 9 will not be described in detail.

The signal judging section 201 and the OSD generating section 911 operate in the same manners as the signal judging section 201 shown in FIG. 2 and the OSD generating section 911 shown in FIG. 9, respectively, and hence will not be described in detail.

The left-eye OSD buffer 1012 stores a left-eye OSD image signal corresponding to the 3D video that is input from the OSD generating section 911 or a 2D OSD image signal corresponding to the 2D video, and outputs the stored OSD image signal to the selector 1014 with prescribed timing.,

The right-eye OSD buffer 1013 stores a right-eye OSD image signal corresponding to the 3D video that is input from the OSD generating section 911 or the 2D OSD image signal corresponding to the 2D video, and outputs the stored. OSD image signal to the selector 1014 with prescribed timing.

If the signal judging section 201 judges that an input video signal is of 3D video, the selector 1014 switches between the left-eye OSD image signal that is input from the left-eye OSD buffer 1012 and the right-eye OSD image signal that is input from the right-eye OSD buffer 1013 with a prescribed timing scheme and outputs the thus-selected OSD image signal to the blending section 1023 on a frame-by-frame basis.

On the other hand, if the signal judging section 201 judges that an input video signal is of 2D video, the selector 1014 switches between the 2D OSD image signal that is input from the left-eye OSD buffer 1012 and the 2D OSD image signal that is input from the right-eye OSD buffer 1013 with a prescribed timing scheme and outputs the thus-selected OSD image signal to the blending section 1023 on a frame-by-frame basis.

If the signal judging section 201 judges that an input video signal is of 3D video, the left/right image separating section 1021 separates the input 3D video signal into two sets of image frames by extracting a left-eye video signal (left-eye image frames) and a right-eye video signal (right-eye image frames) from image frames of the input 3D video signal by performing prescribed processing on a frame-by-frame basis and outputs the two sets of image frames to the frame transfer processing section 1022. If the signal judging section 201 judges that an input video signal is of 2D video, the left/right image separating section 1021 does not separate the input 2D video signal because it does not contain a left-eye video signal and a right-eye video signal. Instead, the left/right image separating section 1021 extracts 2D image frames from the input video signal and outputs them to the frame transfer processing section 1022.

If the signal judging section 201 judges that an input video signal is of 3D video, the frame transfer processing section 1022 transfers (outputs), to the blending section 1023, the left-eye image frames and the right-eye image frames that are input from the left/right image separating section 1021 after arranging them alternately in a time-divisional manner. On the other hand, if the signal judging section 201 judges that an input video signal is of 2D video, the frame transfer processing section 1022 transfers (outputs) the received video signal (2D image frames) to the blending section 1023.

If the signal judging section 201 judges that an input video signal is of 3D video, the blending section 1023 generates new left-eye and right-eye image frames by combining (superimposing) the image frames that are input form the frame transfer processing section 1022 and in which the left-eye image frames and the right-eye image frames are arranged alternately with (on) the left-eye OSD image frames and the right eye OSD image frames that are input from the selector 1014 in synchronism with the image frames that are output from the frame transfer processing section 1022 and outputs the generated left-eye and right-eye image frames to the frame rate converting section 1024. On the other hand, if the signal judging section 201 judges that an input video signal is of 2D video, the blending section 1023 generates new 2D image frames by combining (superimposing) the 2D image frames that are input from the frame transfer processing section 1022 with (on) the 2D OSD image signals that are input from the selector 1014 in synchronism with the image frames that are output from the frame transfer processing section 1022 and outputs the generated 2D image frames to the frame rate converting section 1024.

That is, the blending section 1023 operates in a similar manner for both the 3D video and the 2D video.

If the signal judging section 201 judges that the input video signal is of 3D video, the frame rate converting section 1024 adds interpolation frames (a prescribed number of image frames) based on each of the left-eye and right-eye image frames that are input from the blending section 1023. The frame rate converting section 1024 generates a frame-interpolated left-eye image frame group and a frame-interpolated right-eye image frame group. The frame rate converting section 1024 outputs the image frames of the generated left-eye image frame group and right-eye image frame group to the display unit 61 in prescribed order and causes the display unit 61 to display them.

On the other hand, if the signal judging section 201 judges that the input video signal is of 2D video, the frame rate converting section 1024 adds interpolation frames (a prescribed number of image frames) based on each image frame that is input from the blending section 1023. The frame rate converting section 1024 thus generates a frame-interpolated 2D image frame group. The frame rate converting section 1024 outputs the generated 2D image frames to the display unit 61 in prescribed order and causes the display unit 61 to display them.

The display disabling section 231 operates in the same manner as that shown in FIG. 2 and hence will not be described in detail.

If the signal judging section 201 judges that the input video signal is of 3D video, the shutter control section 81 outputs, to the 3D glasses EG, shutter control signals for opening the left-eye shutter and the right-eye shutter of the 3D glasses EG alternately in synchronism with the output of the left-eye and right-eye image frames from the frame rate converting section 1024. If the signal judging section 201 judges that the input video signal is of 2D video, the shutter control section 81 outputs, to the 3D glasses EG, shutter control signals for opening the left-eye shutter and the right-eye shutter of the 3D glasses EG all the time.

Most of the blocks shown in FIG. 10 need to operate in synchronism with each other according to a prescribed timing scheme so that as described above the shutter control section 81 outputs shutter control signals for opening/closing the shutters with the same timing as the frame rate converting section 1024 outputs image frames. In the second embodiment, it is preferable that the individual blocks shown in FIG. 10 operate in synchronism with each other according to a prescribed timing scheme being controlled by a prescribed sync signal which is managed by the shutter control section 81 based on a timing scheme according which the left/right image separating section 221 outputs image frames. Instead of the shutter control section 81, another block may manage the prescribed sync signal.

In the system configuration of FIG. 10, the “left” and the “right” may be interchanged. More specifically, where an input video signal is of 3D video, opposite OSD image signals (i.e., opposite to the OSD image signals in the system configuration of FIG. 10) are stored in the (right-eye) OSD buffer 1012 and the (left-eye) OSD buffer 1013. The left/right image separating section 1021 outputs opposite video signals to the frame transfer processing section 1022. The “left” and the “right” can be also interchanged for the other blocks.

The system configuration of FIG. 10 may be modified so that the OSD generating section outputs an input 2D video signal to one of the left-eye OSD buffer 1012 and the right-eye OSD buffer 1013 if the signal judging section 201 judges that the input video signal is of 2D video. In this configuration, the selector 1014 is set to select a signal that is input from the one of the left-eye OSD buffer 1012 and the right-eye OSD buffer 1013 that receives the input 2D video signal. The other of the left-eye OSD buffer 1012 and the right-eye OSD buffer 1013 receives no input signal from the OSD image generating section 911 and hence stores nothing.

With the above example system configuration, the signal processing control section 40 performs processing of superimposing a 3D or 2D OSD image signal on an input video signal to display a resulting signal and processing of controlling the 3D glasses EG.

As described above, also in the second embodiment, in the process for superimposing a 3D or 2D OSD image signal on an input video signal to display a resulting signal, a 3D OSD image signal is superimposed on an input 3D video signal and a 2D OSD image signal is superimposed on an input 2D image signal. Image frame groups each consisting of a prescribed number of image frames are generated from image frames in which OSD images corresponding to the input video signal are incorporated, and displayed on the display unit 61 in prescribed order. The opening/closing of the shutters of the 3D glasses EG is also controlled in a manner depending on the type of the input video signal.

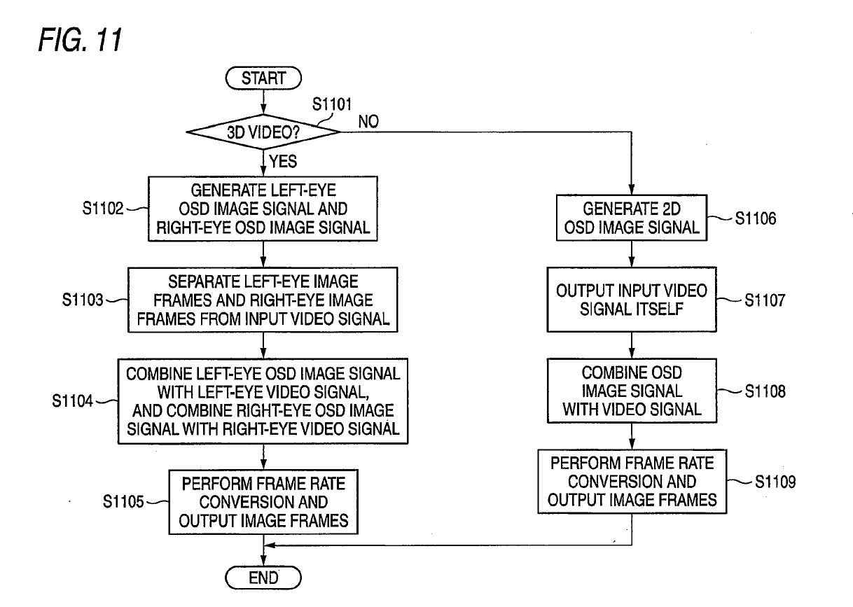

Next, a process which is executed by the above-described blocks to superimpose a 3D or 2D OSD image signal on an input video signal and display a resulting signal will be described with reference to FIG. 11.

FIG. 11 illustrates the example process for superimposing a 3D or 2D OSD image signal on an input video signal to display a resulting signal.

First, at step S1101, the signal judging section 210 judges whether an input video signal is of 3D video or 2D video. If the signal judging section 201 judges that the input video signal is of 3D video (S1101: yes), at step S1102 the OSD signal generating section 211 generates a left-eye OSD image signal and a right-eye OSD image signal and outputs them to the left-eye OSD buffer 1012 and the right-eye OSD buffer 1013, respectively.

At step S1103, the left/right image separating section 1021 extracts (separates) a left-eye video signal(left-eye image frames) and a right-eye video signal (right-eye image frames) from image frames of the input 3D video signal and outputs the extracted signals to the frame transfer processing section 1022. The frame transfer processing section 1022 transfers (outputs), to the blending section 1023, the received left-eye and right-eye image frames after arranging them alternately in a time-divisional manner.

At step S1104, the blending section 1023 generates new left-eye and right-eye image frames by combining (superimposing) the received left-eye and right-eye image frames with (on) the left-eye and right eye OSD image frames that are input from the selector 1014 in synchronism with the image frames that are output from the frame transfer processing section 1022 and outputs the generated left-eye and right-eye image frames to the frame rate converting section 1024. That is, the selector 1014 outputs the left-eye OSD image signal that is input from the left-eye OSD buffer 1012 and the right-eye OSD image signal that is input from the right-eye OSD buffer 1013 to the blending section 1023 in a switched manner on a frame-by-frame basis in synchronism with the output of the left-eye and right-eye image frames from the frame transfer processing section 1022.

At step S1105, the frame rate converting section 1024 output the image frames of left-eye image frame group and right-eye image frame group generated based on the received left-eye and right eye image frames to the display unit 61 in prescribed order to cause the display unit 61 to display those image frames.

On the other hand, if the signal judging section 201 judges that the input video signal is of 2D video (S1101: no), at step S1106 the OSD image generating section 911 generates a 2D OSD image signal and outputs it to the left-eye OSD buffer 1012 and the right-eye OSG buffer 1013. At step S1107, the left/right image separating section 1021 does not separate the input video signal and outputs its 2D image frames to the frame transfer processing section 1022. The frame transfer processing section 1022 transfers (outputs) the received video signal to the blending section 1023.

At step S1108, the blending section 1023 generates new 2D image frames by combining (superimposing) the input video signal that is input from the frame transfer processing section 1022 with (on) the 2D OSD image signal that is input from the selector 1014 in synchronism with the input video signal, and outputs the generated 2D image frames to the frame rate converting section 1024. The selector 1014 outputs the 2D OSD image signal that is input from the left-eye OSD buffer 1013 and the 2D OSD image signal that is input from the right-eye OSD buffer 1013 to the blending section 222 in a switched manner on a frame-by-frame basis in synchronism with the output of the 2D image frames from the frame transfer processing section 1022.

At step S1109, the frame rate converting section 1024 outputs the image frames of 2D image frame groups generated based on the image frames that are input from the blending sections 1023 to the display unit 61 in prescribed order to cause the display unit 61 to display those image frames.

In the above-described manner, the blocks provided in the signal processing control section 40 etc. according to the second embodiment generate an OSD image signal corresponding to an input video signal depending on whether the input video signal is of 3D video or 2D video, superimposes the generated 3D or 2D OSD image signal on the input video signal, and displays a resulting signal.

As described above, in the second embodiment, whether an input video signal is of 3D video or 2D video is judged. If the input video signal is of 3D video, a left-eye OSD image signal and a right-eye OSD image signal that are generated individually are synchronized and combined with a left-eye video signal and a right-eye video signal, respectively, that are separated from the input video signal, whereby an arrangement of image frames is generated. The image frames of the arrangement are output sequentially in prescribed order. If the input video signal is of 2D video, a generated 2D OSD image signal is synchronized and combined with the input video signal, whereby an arrangement of image frames is generated. The image frames of the arrangement are output sequentially in prescribed order. That is, an input video signal can be processed in the same manner irrespective of whether it is of 3D video or 2D video. As such, according to the second embodiment of the invention, video generated by combining a 3D or 2D graphic object with an input video signal depending on the type of the input video signal can be displayed.

The embodiments are not limited to the above configurations, and various changes, modifications, etc. are possible without departing from the spirit and scope of the invention.

According to an aspect of the present invention, there is provided a video combining device, a video display apparatus, and a video combining method which make it possible to display video obtained by combining a graphic object of 3D or 2D with an input video signal depending on the type of the input video signal.

What is claimed is:

1. A video combining device comprising:
a frame extraction module configured to extract, from a 3D video signal including a left-eye video signal and a right-eye video signal, left-eye frames and right-eye frames;
a graphic object generation module configured to generate a left-eye object to be superimposedly displayed on a screen with the left-eye frames and to generate a right-eye object to be superimposedly displayed on the screen with the right-eye frames;
a combined image generation module configured to generate combined left-eye frames by synchronizedly combining the left-eye object and the left-eye frames and to generate combined right-eye frames by synchronizedly combining the right-eye object and the right-eye frames;
a frame group generation module configured to generate a left-eye frame group in which the number of frames is increased and a right-eye frame group in which the number of frames is increased by performing a frame interpolation based on the combined left-eye frames and the combined right-eye frames generated by the combined image generation module; and
an image output module configured to alternately output the left-eye frame group and the right-eye frame group so as to sequentially rewrite a display on the screen so that the left-eye frame group and the right-eye frame group are alternately displayed on the screen.

2. The device of claim 1, further comprising:
a display disabling module configured to disable the display on the screen:
in a first period in which the image output module rewrites one of the left-eye frame group with one of the right-eye frame group; and
in a second period in which the image output module rewrites one of the right-eye frame group with one of the left-eye frame group.

3. The device of claim 2,
wherein, in the first period and the second period, the display disabling module
stops a light emission by a light source for the screen configured of a light-transmission-type video display panel which displays video by receiving a supply of a light from the light source, or
outputs a video signal for bringing the display on the screen into a non-display state.

4. The device of claim 1,
wherein the frame group generation module
copies the respective combined left-eye frames and the respective combined right-eye frames to generate interpolation frames, respectively, and
alternately arranges the interpolation frames and the copy-source frames to generate the left-eye frame group and the right-eye frame group.

5. The device of claim 1, further comprising:
a signal receiving module configured to receive the 3D video signal or a 2D video signal; and
a signal judgment module configured to judge whether the signal receiving module has received the 3D video signal or the 2D video signal,
wherein, if the signal judgment module judges that the signal receiving module has received the 2D video signal,
the frame extraction module extracts 2D frames from the 2D video signal,
the graphic object generation module generates a 2D object to be superimposedly displayed on the screen with the 2D frames,
the combined image generation module generates combined 2D frames by combining the 2D object and the 2D frames, and
the image output module outputs the combined 2D frames so as to subsequently rewrite the display on the screen.

6. The device of claim 5,
wherein a plurality of the combined image generation modules are provided, and
wherein, if the signal judgment module judges that the signal receiving module has received the 3D video signal, the combined image generation modules generate the combined left-eye frames and the combined right-eye frames in parallel.

7. The device of claim 6, further comprising:
a first storage module configured to store the left-eye object;
a second storage module configured to store the right-eye object; and
a selection module configured to selectively output the left-eye object or the right-eye object,
wherein, if the signal judgment module judges that the signal receiving module has received the 3D video signal,
the selection module maintains to select one of the left-eye object and the right-eye object, and
a specific one of the combined image generation modules generates the combined left-eye frames based on the left-eye object selected by the selection module or the combined right-eye frames based on the right-eye object.

8. The device of claim 5,
wherein, if the signal judgment module judges that the signal receiving module has received the 3D video signal, the combined image generation module generates the combined left-eye frames and the combined right-eye frames alternately.

9. The device of claim 8, further comprising:
a first storage module configured to store the left-eye object;
a second storage module configured to store the right-eye object; and
a selection module configured to selectively output the left-eye object or the right-eye object,
wherein, if the signal judgment module judges that the signal receiving module has received the 3D video signal,
the selection module alternately outputs the left-eye object and the right-eye object, and
the combined image generation module generates the combined left-eye frames based on the left-eye object selected by the selection module and the combined right-eye frames based on the right-eye object selected by the selection module.

10. A video display apparatus comprising a video combining device, the video combining device comprising:
a frame extraction module configured to extract, from a 3D video signal including a left-eye video signal and a right-eye video signal, left-eye frames and right-eye frames;
a graphic object generation module configured to generate a left-eye object to be superimposedly displayed on a screen with the left-eye frames and to generate a right-eye object to be superimposedly displayed on the screen with the right-eye frames;
a combined image generation module configured to generate combined left-eye frames by synchronizedly combining the left-eye object and the left-eye frames and to generate combined right-eye frames by synchronizedly combining the right-eye object and the right-eye frames;
a frame group generation module configured to generate a left-eye frame group in which the number of frames is increased and a right-eye frame group in which the number of frames is increased by performing a frame interpolation based on the combined left-eye frames and the combined right-eye frames generated by the combined image generation module; and
an image output module configured to alternately output the left-eye frame group and the right-eye frame group so as to sequentially rewrite a display on the screen so that the left-eye frame group and the right-eye frame group are alternately displayed on the screen.

11. A video combining method comprising:
extracting, from a 3D video signal including a left-eye video signal and a right-eye video signal, left-eye frames and right-eye frames;
generating a left-eye object to be superimposedly displayed on a screen with the left-eye frames, generating a right-eye object to be superimposedly displayed on the screen with the right-eye frames;
generating combined left-eye frames by synchronizedly combining the left-eye object and the left-eye frames,
generating combined right-eye frames by synchronizedly combining the right-eye object and the right-eye frames;
generating a left-eye frame group in which the number of frames is increased and a right-eye frame group in which the number of frames is increased by performing a frame interpolation based on the combined left-eye frames and the combined right-eye frames; and
alternately outputting the left-eye frame group and the right-eye frame group so as to sequentially rewrite a display on the screen so that the left-eye frame group and the right-eye frame group are alternately displayed on the screen.
